(19) United States
(12) Patent Application Publication
(10) Pub. No.: US 2008/0294680 A1
(43) Pub. Date: Nov. 27, 2008

(54) Data Navigation Module, Apparatus and Method

(76) Inventors: Dominic George Thomas Powell, New Malden (GB); Gary Joy, Northampton (GB)

Correspondence Address: Law Office of MICHAEL D. EISENBERG;Intellectual Property Law, 3263 CAMINITO EASTBLUFF, Suite 198, LA JOLLA, CA, 92037, US

(21) Appl. No.: 12/124,408

(22) Filed: May 21, 2008

(30) Foreign Application Priority Data
May 22, 2007 (GB) 5582901

(51) Int. Cl. G06F 17/30

(52) U.S. Cl. 707/102; 707/E17.044

(57) ABSTRACT

A navigation module for a structured database having a multiplicity of dimensions is operative to cause a user interface to display one or more data point values retrieved from the database and to receive user input. The navigation module responds to user selection of one or more presented data point values by causing the user interface to display a first element indicium representative of an element of one or more data point vectors defining a location of the one or more user selected data point values within the database, and to display a second element indicium associated with the first element. The navigation module retrieves from the structured database one or more new data point values corresponding to one or more new data point vectors defined by user selection of the second element indicium, and causes the user interface to display the one or more new data point values.

### CROSS-REFERENCES TO RELATED APPLICATIONS

This application claims priority from U.K. patent application number 5582901 filed May 22, 2007, which is hereby incorporated herein by reference in its entirety.

### TECHNICAL FIELD

The present invention relates to a data navigation module for a structured database, in particular to data processing apparatus comprising a data navigation module and a method for implementing a data navigation module on data processing apparatus.

### BACKGROUND OF THE INVENTION

In a structured database data values are stored at pre-defined locations according to the data value that is to be stored. Structured databases may be highly complex and comprise multi-dimensional databases which provide for data values to be stored, retrieved and analysed for almost any number, and in any combination, of the so-called data or database dimensions.

Within database design nomenclature the term “dimension” is ascribed to the collective attributes of a group of elements. Any given data point value within a multi-dimensional database is described by a combination of the dimensional elements. This is similar to the navigational concepts of latitude and longitude for defining a geographical location. A geographical location may be represented by the vector of X° latitude and Y° longitude. In a similar manner, a data point value within a multidimensional database may be represented and specifically identified by a vector containing as many elements as there are dimensions in the database.

FIG. 1 diagrammatically represents a highly simplified example of a multi-dimensional data structure for a business intelligence consolidation database. For example, the vector of Saturn Telecommunications, UK, finance sector, STG£ managed LAN services in 2006, actual profit will converge on a single data point in the underlying database which gives a sterling value for the actual profit in 2006 for LAN services in the UK finance sector for Saturn Telecommunications. As illustrated in FIG. 1, dimensions 1 are collective attributes such as subsidiary, region, customer, products, time, currency, category and indicator. Within each dimension there are elements 2 which define particular attributes of the dimension. For example, elements of the subsidiary dimension are the individual subsidiaries themselves, i.e. Saturn Telecommunications Ltd and Mars Network Services.

In practice databases, for example a business intelligence consolidation database, are considerably more complex than that illustrated diagrammatically in FIG. 1 and may comprise many hundreds of thousands of dimensional elements. All the possible combinations of all these elements respectively define many tens and even hundreds of thousands (or even more) of data point values.

Consequently users of such structured database systems have access to enormous quantities of data, each item of which is definable in terms of a number of characteristics or dimensions. Whilst this dimensional structure lends itself to efficient data storage and retrieval the very precision of this organisation, and this volume, makes it very difficult for a user to interrogate a database in a meaningful manner without a very detailed knowledge of its structure and content. The dimensional structure of the database system provides users with a framework of the layout of the data and the relationship between individual data items. Additionally, most databases by way of their native query language or by way of systems that run on top of them, are able to collate and represent the data in the form of tables and charts.

However, despite the combination of tabular or graphic representation, dimensional richness and intellectual insight, users often remain ignorant regarding the key issues that are described by the data. Reasons why a user may remain ignorant about what is described by the data may include the fact that the database is generally inflexible. In general, a query is made to the database based upon a particular analytical model, and the relevant data sourced and the model populated. However, usually the analysis is incomplete in that the user often has further questions based on the analysis they have just performed, each of which question requires a similar analytical process of its own. Therefore there is considerable time and effort required for a user to obtain a comprehensive understanding of the key issues within a database.

Additionally, the dimensional hierarchy of the data often obscures key issues within it. For example, within a business consolidation database the favourable profit performance of a company may obscure the losses that might be rapidly accumulating within a group subsidiary. A similar example may be found within a customer relationship management database where stable repeat revenues from a particular client account hides falling numbers of new orders.

Another reason may be that whilst there is a dimensional framework to the data, there is no logic to the layout of the data. For example, in a business consolidation database there may be a dimensional framework that helps a user to retrieve and review a data item (for example cash flow) but no inherent logic which leads or prompts the user to enquire about associated data items such as the variance between cash flow and profit.

Data tables and charts are the only suitable mechanisms for analysing multi-dimensional data as they can graphically present a number of data points in a meaningful and understandable manner. However, each table or chart can only display a very limited number of data points, for example 30 data points, before becoming too complex to represent the data clearly. Such a limited number of data points may comprise less than a ten thousandth or even one millionth or less of the data points available within a multi-dimensional database for example. Therefore, the total number of charts and tables required to provide a comprehensive view of the data without each chart or table being unduly complex would be overwhelming and likely incomprehensible to a user, not least because of the number of options available to the user.

In order to assist in the analysis of such large amounts of data database analytics systems have been developed which combine data tables and charts within a single presentation screen (“dashboard”) in order to graphically present the same or related data in different ways in order to assist a user to understand its significance, and thereby analyse the data. One example of such a conventional analytics system is a so-called hierarchical system in which the data tables and charts within one or more dashboards are customised around the assumed needs of a target user or user group. A fixed or limited number of data table and chart analyses are provided within one or more dashboards, and are intended to be as relevant as possible to the analytical needs of the target user or user group. Typically the data tables and charts are provided to the user on a client-server or Web services basis.

A second example of a conventional analytic system is a so-called personal system in which a large number of data tables and charts are made available to a user or user group. A user or user group may select which one or more of the data tables and charts they wish to incorporate within a dashboard or dashboards customised and developed for their own particular use and needs. Example of a personal analytic system is that produced by Tableau Software of the United States. The Tableau software provides for the dimensions of a display chart to be interchanged so that, for example, a chart which shows product performance within a region can be changed to display regional performance for a product instead.

In general, conventional analytics systems provide charts and tables which whilst aimed at a particular user or user group are required to be sufficiently generic to the overall needs of that user or user group and are not specific to individual members particular needs. Consequently, the value of such analytics systems is reduced for individual users or groups of users and therefore there use is reduced correspondingly.

Furthermore, the hierarchical arrangement of the table and chart analyses within a hierarchical system is substantially inflexible in that the arrangement of the charts and tables cannot easily be changed by a user, and generally can only be reprogrammed by a system administrator or person with a similar level of modification rights and expertise. This is particularly inconvenient when performance conditions or circumstances change, for example a particular product market segment changes character. Additionally, the charts and tables within a hierarchical system whilst displaying performance “exceptions”, that is to say an anomaly or variance, do not provide a mechanism for the exception to be systematically analysed. Additionally, hierarchical systems are not intuitive because a user cannot investigate or perform an analysis of their own choosing, but is limited to selecting only those analytical charts and tables which have been predefined.

Embodiments in accordance with the present invention were devised with the foregoing in mind.

### BRIEF SUMMARY OF EMBODIMENTS OF THE INVENTION

According to one aspect of the invention, the present invention provides a navigation module for a structured database having a multiplicity of dimensions and comprising a plurality of data points. Each data point has a location in the database defined by a data point vector comprising a multiplicity of elements wherein respective elements correspond to respective dimensions of the database. The navigation module is operative to present data point values retrieved from the database on a user interface and to receive user input.

An example of a user interface may comprise a visual display unit (vdu) and the navigation module is operative to display data point values on the display screen of the vdu. The user interface may also comprise a pointing device such as a mouse, or a touch sensitive display screen, and user input may be generated by a user selecting an item displayed on the display screen with the pointing device or touching a corresponding part of the display screen. The user interface may also comprise a keyboard or key pad via which user input may be generated.

The navigation module is operative to: respond to user selection of one or more presented data point values by causing said user interface to present a first element indicium representative of an element of one or more data point vectors defining a location of said one or more user selected data point values within said database; respond to user input to present a second element indicium associated with said first element; retrieve from said structured database one or more new data point values corresponding to one or more new data point vectors defined by user selection of said second element indicium; and cause said user interface to present said one or more new data point values.

Viewed from a second aspect, the present invention provides a method of operating a data processing apparatus for navigating a structured database having a multiplicity of dimensions, said method comprising: causing a user interface to present one or more data point values retrieved from said database and receiving user input; responding to user selection of one or more presented data point values by causing said user interface to present a first element indicium representative of an element of one or more data point vectors defining a location of said one or more user selected data point values within said database; responding to user input to present a second element indicium associated with said first element; retrieving from said structured database one or more new data point values corresponding to one or more new data point vectors defined by user selection of said second element indicium; and causing said user interface to present said one or more new data point values.

An embodiment in accordance with the foregoing aspect may provide a navigation module which enables a user to explore and analyse a structured database through an indefinite sequence of sets of data point values, for example displayed as charts and/or tables, each one leading from and building on the logical insight afforded to a user by the previously displayed set of data point values (chart or table).

In an embodiment each successive set of displayed data point values such as a chart or table may adopt the dimensional logic of its predecessor, other than where the user has deliberately modified the dimensional logic in the displayed data point values (chart or table) by reassigning against which dimension or dimensions one or more data point values will be presented. In this way a user may intuitively navigate through and analyse the data in the database by selecting individual points of note or interest, for example within a chart or table, modify the dimensional logic within a chart or table or for a next chart or table and have a new chart or table presented in accordance with the modified dimensional logic and new data values. Thus, the transition between individual sets of displayed data point values such as charts and tables may be controlled by a user in accordance with the logical flow the user requires or best understands, without a user necessarily having to have previous information about the data within the database.

In an embodiment utilising a vdu as a user interface the navigation module is further operative to display the data point values, the indicia and the indicium on the display screen of the vdu.

Typically, the second element is an element which is associated with the first element, in particular it may be an element along the same dimension of the structured database as the first element. This provides an automated mechanism for proposing changes in the data that is to be analysed in a manner that is similar to the way a human would naturally analyse data. For example, a human user usually makes small changes from the starting point as they develop their analysis of information. In a similar way, by providing a second element associated with the first element, in particular being along the same dimension as the first element, a small change from the starting point is provided. Furthermore, when the first element is one of a primary dimension, it is possible for a user to input plural data elements in order to retrieve plural data values along the dimension.

Viewed from a further aspect, the present invention provides a navigation module for a structured database having a multiplicity of dimensions, said navigation module operative to: cause a user interface to present one or more data point values retrieved from said database and to receive user input; respond to user selection of one or more presented data point values by causing said user interface to present a first dimension indicium representative of a first dimension of one or more data point vectors defining a location of said one or more user selected data point values within said database, and wherein said first dimension indicium is arranged to be indicative of said first dimension being a primary dimension influencing the form in which said one or more user selected data point values are presented; and to respond to user input designating a second dimension of said one or more data point vectors as a primary dimension and influential on the form in which data point values are presented by causing one or more data point values retrieved from said structured database to be presented in accordance with said second dimension being designated a primary dimension.

Viewed from a yet further aspect, the present invention provides a method of operating a data processing apparatus for navigating a structured database having a multiplicity of dimensions, said method comprising: causing a user interface to present one or more data point values retrieved from said database and receiving user input; responding to user selection of one or more presented data point values by causing said user interface to present a first dimension indicium representative of a first dimension of one or more data point vectors defining a location of said one or more user selected data point values within said database, and arranging said first dimension indicium to be indicative of said first dimension being a primary dimension influencing the form in which said one or more user selected data point values are presented; and responding to user input designating a second dimension of said one or more data point vectors as a primary dimension and influential on the form in which data point values are presented by causing one or more data point values retrieved from said structured database to be presented in accordance with said second dimension being designated a primary dimension.

Suitably, the numbers of elements that may be selected for dimensions not designated primary dimensions are limited to one, in order to maintain a clear distinction between dimensions along which plural elements are to be displayed and other dimensions.

Typically, a second dimension indicium representative of said second dimension is presented responsive to user selection of one or more presented data point values since the data point values are stored in a multi-dimensional database and displaying more than one assists a user in obtaining insight into the structure of the database and understanding the data point values presented to them.

The navigation module may be responsive to a user arranging said second dimension indicium to be indicative of being designated a primary dimension by designating said second dimension as a primary dimension. Optionally, or additionally, the navigation module may be responsive to user input to designate both first and second dimensions as primary dimensions. Thus, a user may modify the way data point values are displayed.

In one embodiment, the navigation module responds to a dimension being designated as a primary dimension to present data values in a form in which data values along said primary dimension may be compared.

Optionally or additionally, the navigation module responds to a dimension being designated as a primary dimension to present data values in a form in which said dimension forms an axis of a graphical presentation.

Optionally or additionally, the navigation module responds to a dimension being designated as a primary dimension to present data values in a form in which more than one data value along said primary dimension is presented.

In one embodiment user input defining a data presentation type for presenting data point values causes the one or more new data point values to be presented in accordance with the data presentation type. Thus, a user may select the form in which the data point values are presented to them and thereby select a presentation form which they find clear and intuitive.

In particular, the data presentation type is a graphical presentation, which is a particularly suitable form of presenting data clearly.

Suitably, user input is received from the interface. This is a convenient arrangement in that the user interface resource is used for both presenting the data point values and for receiving user input.

One embodiment of the present invention may be implemented in a data processing apparatus. The data processing apparatus comprises a processing resource, a memory resource and an interface resource. Computer program elements for implementing the navigation module are stored in the memory resource and forwarded to the processing resource as required, for causing the processor to operate in accordance with the navigation module.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a graphical representation of the dimensions and elements in an illustrative structured database;

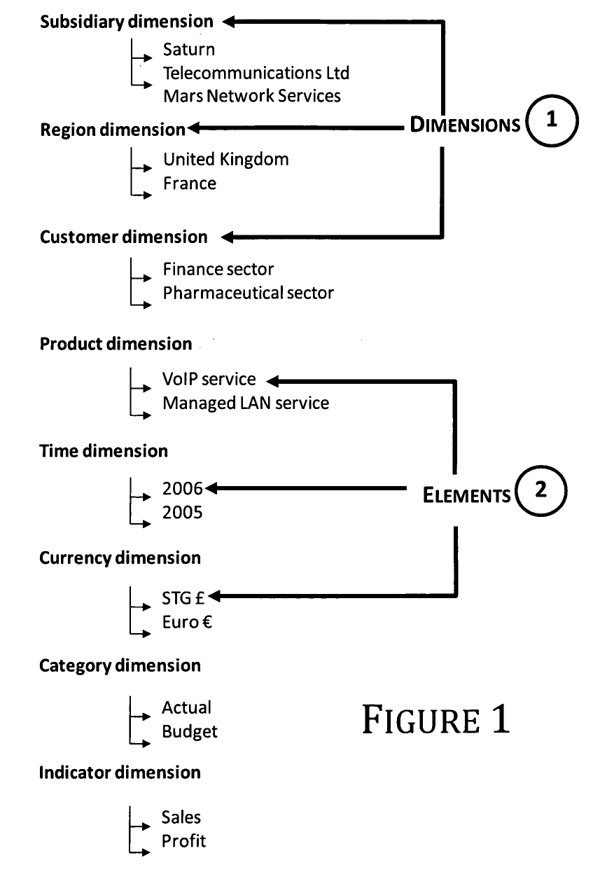

FIG. 2 schematically illustrates a system including data processing apparatus configured in accordance with an embodiment of the present invention;

FIG. 3 schematically illustrates the architecture of a navigation module in accordance with an embodiment of the present invention;

FIG. 4 schematically illustrates the architecture of a navigation component in accordance with an embodiment of the present invention;

FIG. 5(a) schematically illustrates the screen layout for a navigation interface for user selection of dimensions and elements in accordance with an embodiment of the present invention;

FIG. 5(b) schematically illustrates the screen layout for a navigation interface recording user selected dimensions and elements in accordance with an embodiment of the present invention;

FIG. 6 schematically illustrates the architecture of an operational data component in accordance with an embodiment of the present invention;

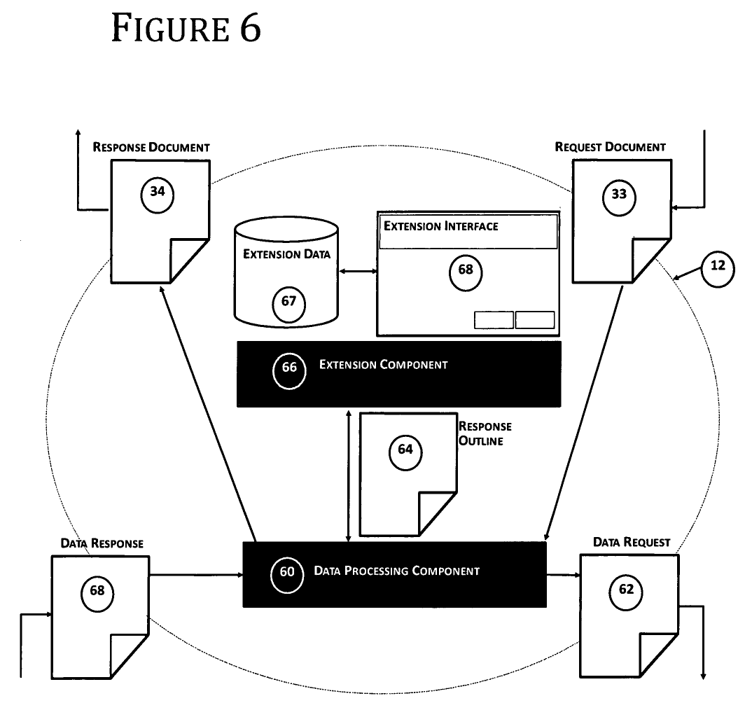

FIG. 7 schematically illustrates the architecture of a data access component in accordance with an embodiment of the present invention;

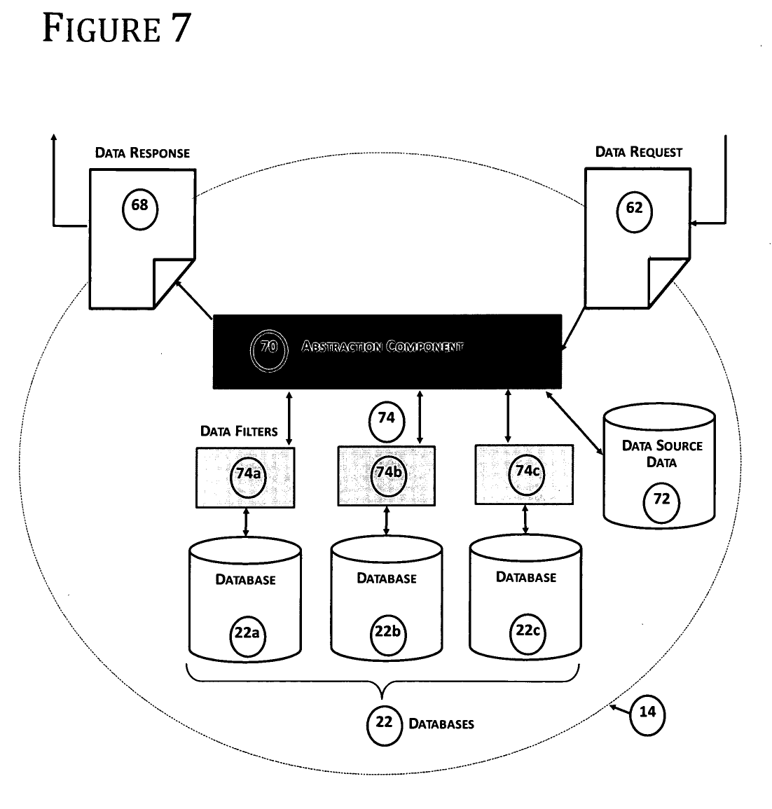

FIG. 8 is an illustration of a trend bar chart;

FIG. 9 is an illustration of a bridge diagram;

FIG. 10 schematically illustrates the screen layout for a navigation interface recording a user selected PIP from the chart of FIG. 8 and corresponding dimensions and elements in accordance with an embodiment of the present invention;

FIG. 11 schematically illustrates another screen layout for a navigation interface recording a user selected PIP from the diagram of FIG. 9 and corresponding dimensions and elements in accordance with an embodiment of the present invention;

FIG. 12 schematically illustrates a further screen layout for a navigation interface recording user selected PIP and corresponding dimensions and elements in accordance with an embodiment of the present invention;

FIG. 13 is an illustration of a trend bar chart corresponding to the data request specified by the navigation interface illustrated in FIG. 12;

FIG. 14 is an illustration of an extension data interface for forming structures; and

FIG. 15 is an illustration of an extension data interface for extending element data.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

In general outline embodiments of the present invention provide what is termed herein as pathfinder information point (PIP)-based navigation using structured graphical representations to convey in-depth, quantitative insight into an entire database. This is achieved by using so-called quantitative intelligent icons (QII) such as charts or data tables. QIs provide a graphical representation of data selected from the complete set of data within the database, in order to allow a user to build an understanding of and insight into the data.

A QII is the graphical representation of data point values retrieved from a database and presented to a user, for example displayed on the screen of a visual display unit (vdu), and may be in the form of a chart or table for example.

Sub-areas within each QII provide a mechanism by which a user may request the creation and display of new QII representations of either the same, or different, data sub-sets. Such sub-areas are termed pathfinder information points(PIPs) and may comprise a bar in a bar chart or a number within a data table for example. In general terms, a PIP is a displayed data point value in a QII and is selectable by a user to cause the coordinates (vector) of that data point value in the database to be displayed. Modification of the displayed coordinates result in a new QII (chart or table) being generated displaying data point values corresponding to the modified coordinates.

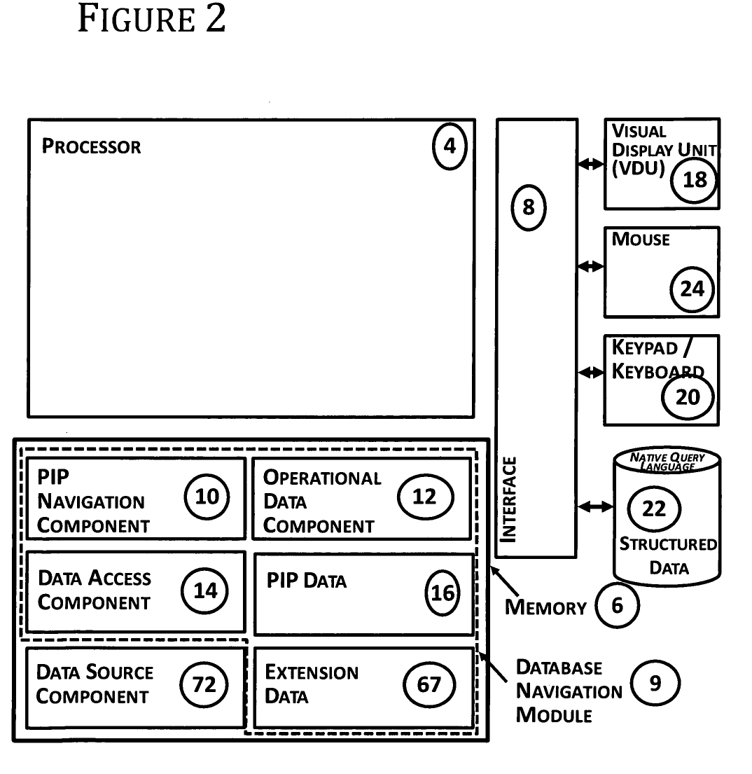

FIG. 2 provides a schematic illustration of data processing apparatus 3 configured in accordance with an embodiment of the present invention. The data processing apparatus 3 is configured as part of a computer system which includes a graphical or visual display unit 18, a keyboard 20 and a pointing device such as a mouse 24.

Data processing apparatus 3 includes a processor 4 providing a processing resource for executing computer program elements such as computer program instructions, parameters and data for performing the necessary functions to implement a database navigation module 9, stored in memory 6, in accordance with an embodiment of the invention.

Processor 4 is coupled to memory 6 for receiving program elements from memory 6, and for storing results of executed operations in memory 6. Data processing apparatus 3 includes an interface 8 for interfacing processor 4 with other elements of the computer system for example vdu 18, keyboard 20 and mouse 24. Interface 8 also provides an interface to a structured database 22. Structured database 22 may be local to the computer system and therefore, for example, interface 8 need only comprise a simple local area network interface for communicating with a database 22. Optionally, database 22 may be located remote from the computer system, and therefore interface 8 may comprise a wide area network interface.

Memory 6 stores various components for implementing the navigation module 9 and also data used in the navigation module. The components include a PIP navigation component 10, an operational data component 12 and a data access component 14 each comprising program elements executable by processor 4 to perform the various functions of the navigation module 9. Additionally, memory 6 includes a region for storing PIP data 16 and other data used by the navigation module 9. It will be evident to a person of ordinary skill in the art that memory 6 may also store other executable code, parameters and data.

Navigation Module Architecture

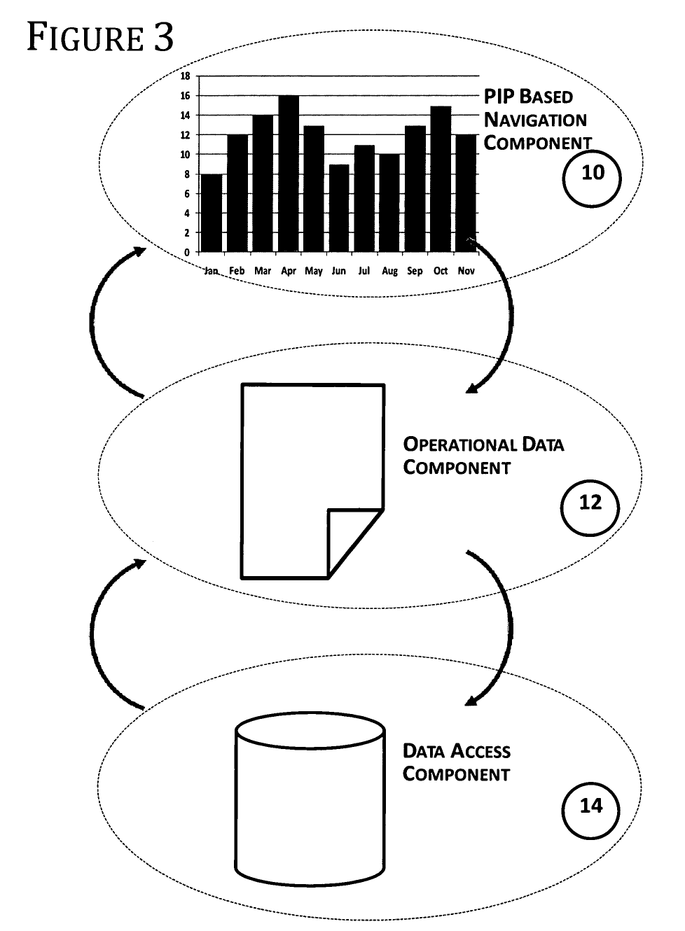

The architecture of the navigation module 9 will now be described with reference to the schematic illustration of FIG. 3. Navigation module 9 comprises three components: a PIP-based navigation component 10; an operational data component 12; and a data access component 14.

The PIP-based navigation component 10 provides a user navigation interface through which a user may identify a data item or a data sub-set of the database which is of interest to them, and to perform data analysis upon the identified data.

The navigation interface provides details of the data item or data subsets identified by the user to the operational data component 12, which forms data requests for data from database 22, and forwards the data received from database 22 back to the navigation component 10. Additionally, if the data item or data subset requested by the navigation component is not available from database 22, operational data component 12 provides an extension interface through which a user may input data which supplements the data contained in database 22 and thereby extends the database.

For example, the extension interface may be used to define a hierarchy for data in the database that is stored within a “flat” structure. An example may be for data on towns and cities in the United Kingdom. The data stored in the database may comprise the entries: “England”; Newport; “Scotland”; London; “UK”; Canterbury; Edinburgh; “Northern Ireland”; Glasgow; Cardiff; “Wales”; Belfast; and Londonderry. By way of the extension interface a user may define a hierarchy of:

UK->
i. England->London, Canterbury
ii. Scotland->Edinburgh; Glasgow
iii. Wales->Cardiff; Newport
iv. Northern Ireland->Belfast; Londonderry

The extension interface provides a convenient mechanism for enhancing the data retrieved from the database.

In response to receiving details of the data identified by the user, the operational data component 12 makes a data request to data access component 14 which retrieves the requested data from database 22 and provides it back to the operational data component 12.

Operation of the Navigation Module

The navigation module 9 is initiated when a user requests or indicates that they wish to display data from a structured database. This may be as part of an application program executing on the computer system for interrogating a structured database. For example, a user may be presented with a list of menu options displayed on the screen of the vdu 18, of which one option is to configure a display object.

A display object may be a defined space or area on the screen of the VDU 18 into which QIIs may be displayed. The instructions for the display object are part of the PIP-based navigation component 10, and are executed in response to the navigation component 10 being investigated by user selecting the option to configure a display object.

Control signals for formatting the display object are sent from processor 4 over interface 8 tovdu 18. Processor 4 generates the control signals for configuring the display object in accordance with application program instructions, parameters and data stored in memory 6. Typically, the application program instructions are loaded into memory 6 from a disc or downloaded over a network, for example.

Once the display object has been displayed on the display screen, operation of the navigation component 10 is continued.

PIP-Based Navigation Component Data Request

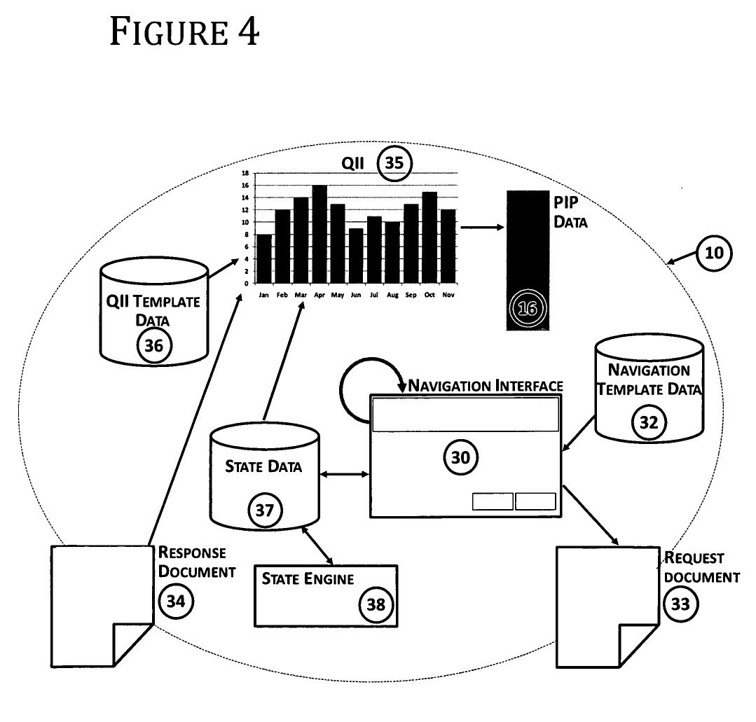

Referring now to FIG. 4, operation of the navigation component 10 is centred on the navigation interface 30. In the described embodiment, a user may move the cursor of a pointing device, such as a mouse, into the display object and initiate the navigation interface by actuating a button on the pointing device, for example the “left” button on a mouse. The navigation box appears as an input “window” in the display object.

The navigation interface 30 provides a user interface for specifying upon which one or more of the dimensions existing within a structured data base a QII is to be based. That is to say, which dimensions will be pivotal to the manner in which the QII will be displayed. These “pivotal” dimensions are termed herein “primary dimensions”. An example of such a user selection of primary dimensions would be where a user selects the dimension of “time” as a primary dimension for a visual representation of data in a QII such as a trend chart.

Additionally, the navigation component 10 displays information to a user and provides a mechanism through which a user may select items displayed in the display object, and input control signals to indicate selection of those displayed items. Navigation interface 30 is displayed on the vdu 18 in accordance with control signals sent from central processor 4 via interface 8. Navigation template data 32 is stored in memory 6 and is forwarded to processor 4 in order to configure the display of navigation interface 30, and also includes information on links for navigating between objects displayed in the navigation interface 30.

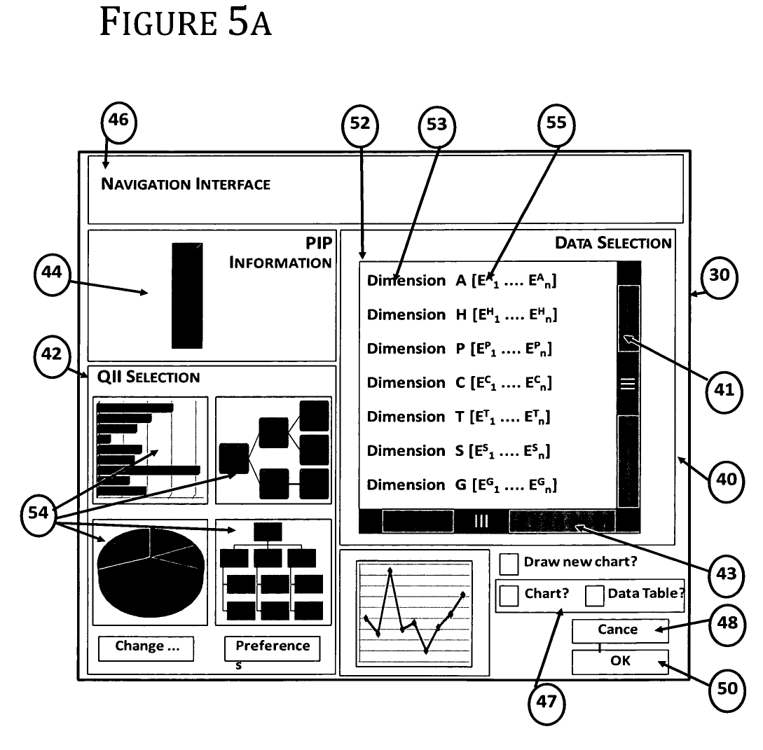

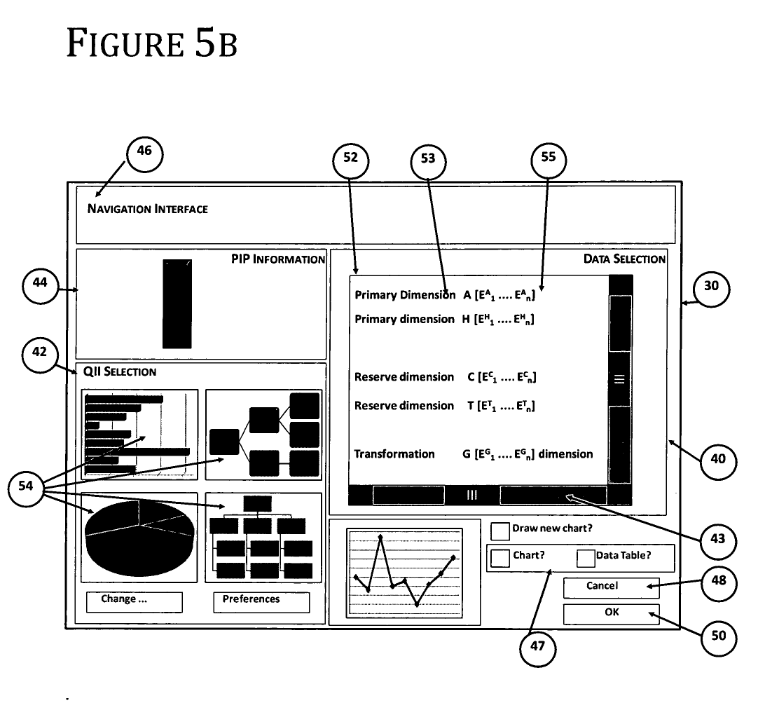

An example of the layout of navigation interface 30 in accordance with the present embodiment is illustrated in FIG. 5. The navigation template data 32 configures the navigation interface 30 to include a data selection area 40, a QII selection area 42 and a PIP information area 44. A screen title area 46 may also be provided.

The navigation interface 30 also includes two user actuable screen-based buttons 48 and 50, respectively labelled “Cancel” and actuable to cancel a display screen and labelled “OK” actuable to confirm that data defined in the navigation interface is correct and to initiate the next stage of the navigation component.

Screen-based buttons 48 and 50 may be actuated by user placing a screen cursor controlled by pointing device such as a mouse 24 over the displayed button (sometimes termed “mousing over”) and activating a mechanical button on mouse 24 which sends a select signal to processor 4 via interface 8. Processor 4 receives signals from mouse 24 which indicate the position of the cursor on the display screen of the vdu 18, such that when the processor 4 receives the select signal the processor initiates the function corresponding to the selected button.

A user may select the data they wish to analyse and have displayed in the display object by inputting into the data selection area 40 of navigation interface 30 the coordinates of the data point or data points of interest to them. In the described embodiment, processor 4 is configured to display automatically in data selection area 40 a list 52 of the dimensions and elements for the data in structured database 22. In the illustrated embodiment, the list 52 is configured as a window in which the dimensions 53 and elements 55 are displayed and through which a user may browse using the slider bars 41 and 43

In the described embodiment, the navigation component 10 requires a user to select which of the displayed dimensions 53 determine the manner in which the data is to be displayed in the QII format that the user selects. The dimensions selected by the user to determine the manner in which data is to be displayed are termed herein “primary dimensions”.

A primary dimension is one for which a user wishes to see one or more values of an element of a selected dimension displayed, such as when a user wishes to compare the values. For example, a user would select the dimension of “time” as a primary dimension for representing data in a QII configured as a trend bar chart in order to have plural values displayed along the time axis, one value for each unit of time along the axis. Additionally, if values for more than one element of the selected dimension are to be displayed then the selected dimension is also a primary dimension.

Viewed from another aspect, a dimension designated a primary dimension, unlike other dimension, comprises multiple elements which are displayed alongside one another in a single chart. The value of displaying these multiple elements within a single chart is that it enables a user to identify trends, to assess correlation and to pinpoint variance. Secondly, each multidimensional database comprises many dimensions. The designation of a dimension as a primary dimension by a user via the navigation interface (30) signals to the navigation module 9 which of these multiple dimensions the user wants to assess and compare the selected component elements of, and to which the navigation module responds by arranging the display of the chart or table accordingly.

A user may move the slider bars 41 and 43, for example by placing a pointing device such as a mouse one of the arrows of a slider bar, to highlight a particular dimension. The user may select a highlighted dimension by scrolling down the list 52 and, for example, by double clicking the “right” button on a mouse or pressing a key on the keyboard, select the highlighted dimension as a primary dimension. Once a dimension has been selected as a primary dimension, a user may select one or more of the elements 55 of the selected dimension, for example by double clicking the “left” button on a mouse or pressing a key on the keyboard.

A user may select as many elements of a primary dimension they wish to be displayed. However, if a dimension is not designated a primary dimension then only one element may be selected.

Optionally, or in an optional embodiment, a user may select dimensions as primary dimensions, and respective elements or element of the selected primary dimensions and a single element of other dimensions, solely using a keyboard 20. Further optionally, or in a further optional embodiment, a user may select a dimension as a primary dimension from a static list of dimensions, for example by “mousing over” the displayed dimension and clicking on one of the mouse buttons, thereby causing processor 4 to highlight the “moused over” dimension. For example, to designate a primary dimension the “right” mouse button is actuated.

Furthermore, selecting the displayed dimension may cause processor 4 to display on the vdu 18 a sub-list of elements for that dimension. The user may then select one element (any dimension) or elements (primary dimensions only) from the sub-list to define the location of the data they wish to retrieve from the database 22.

FIG. 5(b) schematically illustrates a navigation interface 30 in which selected and designated dimensions are displayed in the data selection region 40. In the described embodiment, primary dimensions and their selected elements are indicated by a “P”. Optionally or alternatively primary dimensions may be indicated by being placed in particular locations, for example primary dimensions may be moved to an upper section of the data selection region 40. In general the dimension labels (indicia) may be arranged in any suitable way to indicate a dimension is a primary dimension, such as position in the interface screen or an additional indicium such as a “P” or “*”.

The QII 35 format for the display of data to be retrieved from structured database may be determined by a user selecting which of a number of QII formats displayed in QII selection area 42 they wish to have the data displayed in. In the described embodiment selection of a format is by way of a user placing a pointing device 24 controlled screen cursor, such as a “mouse”, over a particular representation 54 of a QII format and pressing a mechanical key on the pointing device 24, such as the “left” or “right” button on a “mouse”, to send a select signal to processor 4 indicating selection of that particular representation 54.

The navigation interface component 10 includes a state engine 38 which monitors the navigation interface 30. As a user specifies the data to be retrieved, state engine 38 stores state data 37 in memory 6 concerning the data retrieval specification. The state data 37 comprises for example information regarding which elements have been selected, which dimensions are primary dimensions and reserve dimensions and the QII template selected by the user.

State data 37 is continually updated by the state engine 38 as selections are made by a user through the navigation interface 30. Additionally, state data 37 is used by state engine 38 to determine what is displayed in the navigation interface 30, for example which QII formats 54 might be displayed in the QII selection area 42 depending on the dimensions designated as primary dimensions and the elements selected by the user. Also, when data has been retrieved from database 22 state engine 38 updates the state data 37 and the navigation interface 30.

Once a user has a selected the elements defining the vectors of the data items they wish to retrieve and selected which QII format they wish to have the retrieved data displayed in, they may actuate display “button” 52 indicate that they have finished specifying what data they want retrieved and how it is to be presented.

Actuation of “button” 52 results in a signal being sent over interface 8 to state engine 38 which responds by generating a request document 33. Request document 33 comprises a set of dimension elements corresponding to those input by the user via the navigation interface 30 and stored as state data 37. The set of dimension elements in the request document 33 represents one or more vectors defining the location of one or more data items in the structured database 22.

Operational Data Component Request

Processor 4 is configured in accordance with the navigation module 9 to invoke the request phase of operational data component 12 in response to the navigation component 10 generating a request document 33. The request document is passed to the operational data component 12 executing on processor 4, and the data requests therein forwarded to the data processing component 60 of the operational data component 12. The operational data component 12 creates a data request 62.

Operational data component 12 is configured such that in creating data requests for data from structured database 22 information obtained from the request document 33 is modified, as necessary, to suit. The data processing component 60 compares the data elements requested in request document 33 with a list of data elements that may be found in structured database 22. For example, data processing component 60 may be provided with so-called meta data regarding the data elements stored in database 22. The data processing component 60 forms a data request document 62 which includes a request for only those data components which can be found in the structured database 22.

If a request document 33 contains a request for data elements that are not found in the structured database 22 or in a different format to that requested, data processing component 60 invokes an extension component 66 which causes the visual display unit 18 to display an extension interface 68. The extension interface 68 provides a user interface for inputting into the data processing component 60 data elements that are requested in request documents 33 but not contained in the structured database 22. Such data is termed extension data 67.

The extension data 67 contains metadata and data extensions input by the user for structure database 22. Extension data 67 is stored in memory 6 and also comprises data on the metadata itself and the data capacity of the structure data base. If the extension data 67 already comprises metadata and data extensions that resolve, for example, a request for data elements that are not in the structured database or are in a different format to the requested then the extension interface is not invoked and the existing extension data 67 is utilised by the extension component 66.

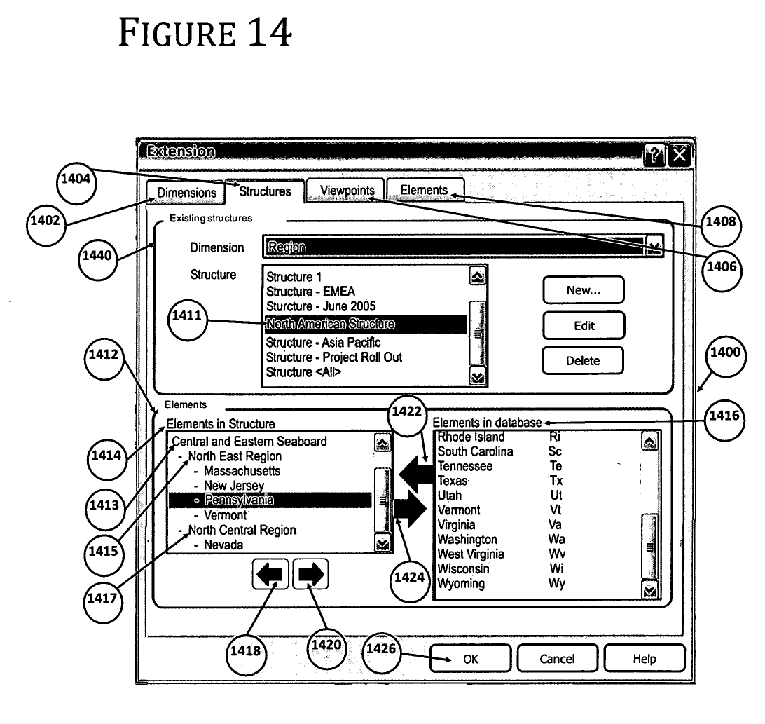

An example of an extension interface is illustrated in FIG. 14. The extension interface 1400 is a window that appears on the display screen of vdu 18. Various aspects of databases may be extended using the extension interface 1400, and in the illustrated embodiment each type has a separate tab; “Dimensions” 1402; “Structures” 1404; “Viewpoints” 1406; and “Elements” 1408. Extension interface 1400 has the “Structures” tab 1404 active. Within the extension database there are existing structures 1410 which are displayed in the upper region of the tab 1404. New structures may be created and these will then be displayed as existing structures.

In FIG. 14 the North American Structure 1411 is highlighted, and so in the lower region 1412 of the tab 1404 are displayed the structure elements 1414 that are in the North American Structure 1411. The database elements 1416 are displayed adjacent the structure elements 1414.

When creating a new structure the elements window 1412 may be configured by entering the name of an element in the structure and activating one or other of tab buttons 1418 and 1420 to indent the elements appropriate to their position in the structure. In this way, the structure elements “Central and Eastern Seaboard” 1413, “North East Region” 1415 and “North Central Region” 1417 are established as being at the top of the structure hierarchy. Database elements 1416 may be selected, e.g. by “mousing over”, and clicking a button the mouse. Arrow button 1422 may be actuated by a user to move a selected database element into the element structure region 1414, and also an element in the element structure region 1414 may be selected and moved to the database element region 1416 by actuating arrow button 1424. Optionally or alternatively, an embodiment may be configured to utilise a “drag and drop” approach such as used in Microsoft™ applications.

Actuating the “OK” button 1426 causes the extension data to be stored so that the structure can be applied to data retrieved from structured database 22.

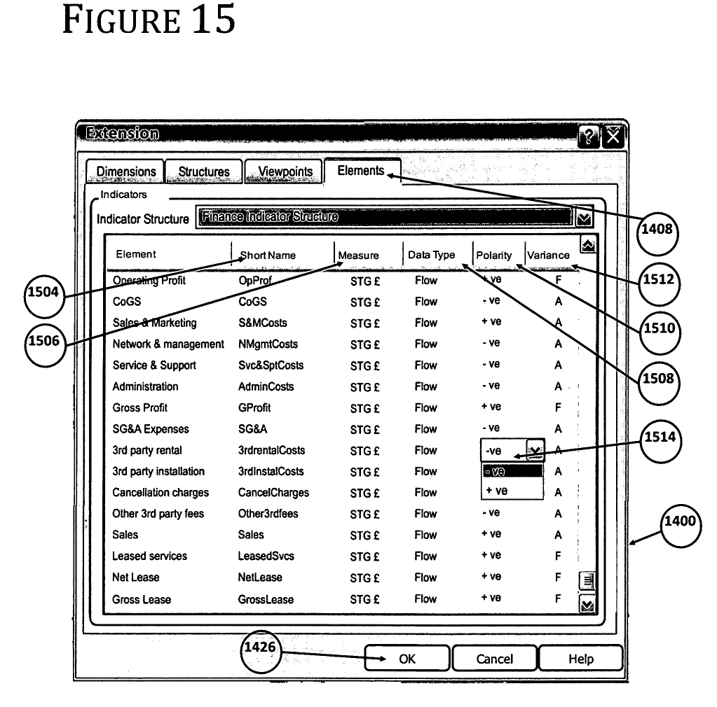

Another example of extension interface 1400 is illustrated in FIG. 15, where tab 1408, the “elements” tab, is active. In the elements tab 1408, a user may configure extension data to provide more information about elements retrieved from database 22. The Finance Indicator Structure 1502 illustrated in FIG. 15 provides for various qualities or attributes to be assigned to element data. By way of non-limiting example, a short name 1502, a measure 1506, a data type 1508, a polarity 1510 and a variance 1512 may be assigned to elements.

A user may move a mouse pointer into one of the columns illustrated in FIG. 15, for example the polarity column 1510, to initiate the display of a simple options window 1514 providing the option of selecting a positive or negative polarity. Once the element attributes have been configured to a user's satisfaction the user may actuate the “OK” button 1416 to store the extension data.

The data processing component 60 of the operational data component 12 forms a data request document 62 which it passes to the data access component 14.

Data Access Component Request and Response

The navigation module 9 invokes the data access component 14 when a data request document 62 has been prepared by data processing component 60 of the operational data component 12. The data request document is transformed by the data access component into a request for data which is input to the abstraction component 70.

Abstraction component 70 identifies to which of one or more databases 22 a data request document 62 refers and retrieves relevant access data for that database from data source data 72, stored in memory 6. For example, data source data 72 may include connection information for a requested database such as the username and password, and location information such as the server location and database name. Thus, the abstraction component 70 provides a mechanism by which a data request 62 may be made to one of many databases 22 with the information for locating and connecting to be requested database being obtained by the abstraction component 70.

The data access component 14 includes data filters 74, one each, 74a and 74b, for each data source 22a and 22b (database 22). Respective data filters 74a and 74b are configured to convert data requests originating from abstraction component 70 into data source specific syntax, such as a native query language syntax, for each data source. Data point values are retrieved from a data source 22a or 22b and are converted by their respective data filter 74a or 74b into a common format for abstraction component 70. Abstraction component 70 forms an XML data response document 68 which it forwards to the data processing component 60 of the operational data component 12.

Operational Data Component Response

Data processing component 60 of the operational data component executing on processor 4 creates a response outline 64, which is an XML document having no data. The response outline may be created during the response or request phase of the operational data component. The response outline 64 is populated with data by the data processing component 60 according to extension data that is supplied to the data processing component 60 from the extension component 66, and also with data from the data response document 68 forwarded form the data access component and containing data retrieved from the structured database 22. The populated response outline 64 forms XML response document 34 which is forwarded to the navigation component 10.

PIP-Based Navigation Component Data Response

Navigation component 10 configures processor 4 to receive a response document 34 which contains the data requested in request document 33. The cached state data 37 that formed the basis for the original data request is retrieved from memory 6. Navigation component 10 builds a QII 35 using the data in response document 34 and the cached state data 37. For example, the QII 35 may be built in accordance with QII template data 36 for the QII format specified by the user in the request phase of the navigation component 10.

Data for the QII 35 is stored in memory 6 and is displayed on the vdu 18. The QII may be automatically displayed on the vdu 18 once the QII 35 has been built, or in response to a user confirming that they want the QII displayed. The QII is displayed in the display object.

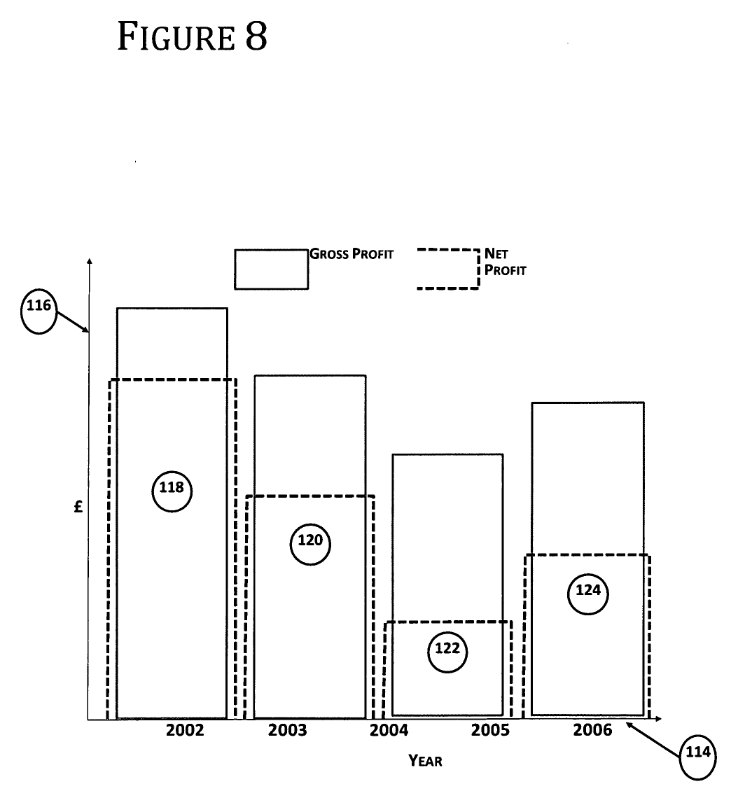

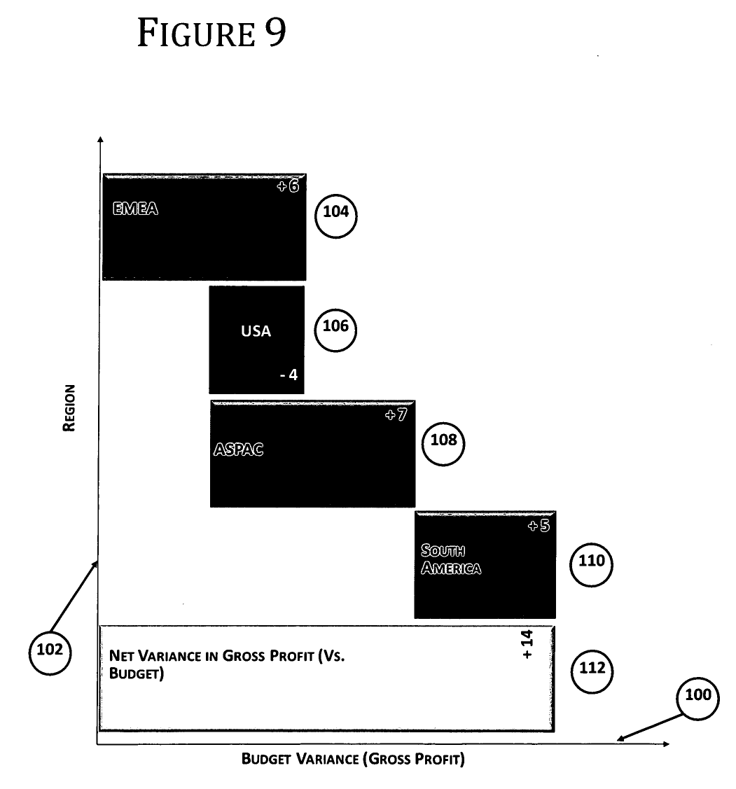

Examples of QIIs 35 are illustrated in FIGS. 8 and 9 of the drawings. FIG. 8 illustrates a trend bar chart having the dimension of time along the x-axis 114, and divide into units of one year. The y-axis 116 represents the dimension “indicator” (which is a dimension whose elements are things whose values are of interest to a user such as “number of sales”, “profit”, “value of sales” etc.). The height of each bar, 118, 120,122 and 124 represents the gross profit in a particular year. The broken outline bars represent net profit and will be discussed in detail later.

FIG. 9 illustrates a “bridge chart” in which the x-axis 100 represents an indicator dimension “budget variance” (which is the difference between budget and actual for a particular indicator, for example gross profit). The y-axis 102 represents the dimension “Region”, and is divided into respective sales regions. For each region 104, 106, 108 and 110 a bar extends horizontally by an amount corresponding to the budget variance. Additionally, there is a total variance bar 112. The starting point for each region bar is the end point of a previous region bar, which in the illustrated example is the region bar immediately above it. The first bar in the sequence 104 starts at zero variance. As can be seen from FIG. 9 the variance for each region is graphically represented together with the total variance.

Layout of a chart is determined by the template data maintained in the QII template data 36. Each chart template in the QII template data 36 is designed and structured in such a way to require a threshold number of primary dimensions in order for it to display. If fewer dimensions than the required threshold are designated as primary dimensions then the selected chart template is unable to display. This may be pre-set as part of the navigation component 10 when determining the types of chart available to be selected from region 54 of the navigation interface 30.

Although in theory there is no upper limit on the number of dimensions that can be designated as primary dimensions, there is a practical upper limit built because the complexity of each chart template increases with the number of designated primary dimensions to the point where either the analytical value of the chart template is erased or where the chart itself is unable to display. The upper limit on primary dimensions designatable for any chart template is a matter of design choice when configuring and implementing the navigation module 9.

The concept of primary dimension and how a chart uses primary dimensions to format the display of data point values will be further described below with reference to the charts illustrated in FIGS. 8 and 9.

Firstly, the vertical bar chart illustrated in FIG. 8 with reference to the solid line bars will be used as an example. The basic vertical bar chart template is structured so that an undefined number of elements within a single primary dimension can be displayed across the X-axis. A vertical bar is displayed for each of those elements, the respective height of which is determined by the user nomination of a single unit of measure. In the illustrated embodiment the unit of measure is gross profit in pounds sterling is gross profit.

For the basic vertical bar chart one dimension, and no more than one dimension, needs to be identified by a user as being a primary dimension. If the time dimension is designated as being the primary dimension as in the illustrated example, then each of the constituent time elements will be displayed on the X-axis of the vertical bar chart (year one, year two, year three etc). The vertical bars above each of the user-nominated time elements represent the scale of performance for each of those time periods as measured against a single unit of measure which is represented by only one element contained within a dimension (e.g. the indicator dimension which comprises elements such as revenue, gross profit, costs etc). If, via the navigation interface (30), a user selects more than one primary dimension, then the vertical bar chart cannot display since it is structured to display no more than one primary dimension at a time along the X-axis, and the navigation interface would indicate an error and request the user to select another chart or just have one primary dimension.

Of course, a user can change their selection of the single primary dimension. So for example, the user can select the indicator dimension to be the primary dimension in place of the time dimension. This would be done within the navigation interface 30 which when it is displayed, shows all of the dimensions within the source multidimensional database and which exhibits the time dimension as being a primary dimension. Specifically, the user replaces the time dimension as the single primary dimension with the indicator dimension. The ‘deselected’ or replaced time dimension is undesignated as a primary dimension. The chart is then automatically updated to show all the indicator elements within the indicator primary dimension along the x-axis of the vertical bar chart. The scale of performance for each of the individual indicator elements is represented by a vertical bar which can be measured against a single element within a dimension which is displayed along the Y-axis (e.g. the currency dimension).

If the user needed to have a second primary dimension, then they would require a multiple bar chart template for the second primary dimension to be displayed along with the X-axis, and should make the appropriate selection of a multiple bar chart template in region 54 of the navigation interface 30. The display when more than one indicator value is illustrated in FIG. 8 with reference to both the solid and broken outline bars, where the solid line represents gross profit and the broken outline represents net profit.

A further example is the bridge chart illustrated in FIG. 9. A bridge chart is structured to show how performance variance for multiple elements within one primary dimension has accumulated over a single time period (i.e. a non primary dimension) in order to determine or explain the performance outcome for another primary dimension. In the illustrated embodiment a bridge chart is structured so that no more and no less than three primary dimensions are required, one of which has to allow for the calculation of variance (either against budget or against a previous time period). If the category dimension is selected, it needs to comprise no more and no less than two elements (i.e. actual and budgeted performance). For example, if time was made the primary dimension, then the user would have to nominate two user time elements for which the variance could be calculated. The user nomination of these two elements (actual and budget) via the navigation interface 30 instructs results in retrieval of both actual and budgeted data for the other two nominated primary dimensions and to subtract one from the other in order to calculate variance. One of the remaining primary dimensions will comprise no more and no less than one element. The third remaining primary dimension will comprise no less than two or more elements.

The user could, for example, nominate—via the navigation interface 30—the region and indicator dimensions as the required extra two primary dimensions. Specifically, via the navigation interface 30, the user nominates Gross Profit as the required element in the indicator primary dimension and then, in the same way, selects multiple elements within the region primary dimension.

The navigation component interprets these three primary dimension selections as follows:
a. Category dimension: the variance between the two selected elements should be calculated for both of the other two selected primary dimensions;
b. Region dimension: since the region dimension comprises multiple element selections the requested calculation of variance should be applied to each selected region element. The individual variances should then be accumulated. The region dimension will be displayed along the y-axis.
c. Indicator dimension: since the indicator dimension comprises only one element selection (e.g. gross profit), the indicator dimension should be presented on the x-axis. Total variance for that selected indicator element should be calculated over the entire nominated time period (defined by the user as a single time elements within the time dimension which is a reserve dimension).

The size of each horizontal bar within a Bridge chart (representing both region and indicator performance variance) shows the scale of variance for each of the individual elements. In addition, colour may be applied to each of the horizontal bars to make more explicit those instances of positive and negative variance (e.g. blue denotes favourable variance whilst red denotes adverse performance).

Given the above user defined settings that have been made via the navigation interface 30, the bridge chart now shows the gross profit performance variance for each of the selected regions and how they have combined to result in an overall variance in gross profit over a time period.

If the user had nominated only one region element but multiple indicator elements, then the pre-coding of the Bridge chart would cause it to accumulate performance across the multiple indicator elements.

The bars in FIGS. 8 and 9 represent data point values retrieved from the structured database 22. As described in general outline above one or more of these data point values displayed in the QII may comprise a Pathfinder Information Point (PIP). In the described embodiment and referring to FIGS. 8 and 9, the PIPs are bars 118, 120, 122 and 124 of the trend bar chart of FIG. 8, and bars 104, 106, 108, 110 and 112 of the bridge chart of FIG. 9.

When the QII 35 is displayed, the user can operate the pointing device to select anywhere from one to all-available PIPs within it. For example, using a mouse a user may place the pointer over a PIP, which highlights the PIP, and select that PIP by clicking the “left” button on the mouse. More than one PIP may be selected my moving the mouse pointer over each desired PIP and pressing the “right” button to maintain the highlighting and then clicking the “left” button to select all the highlighted PIPs.

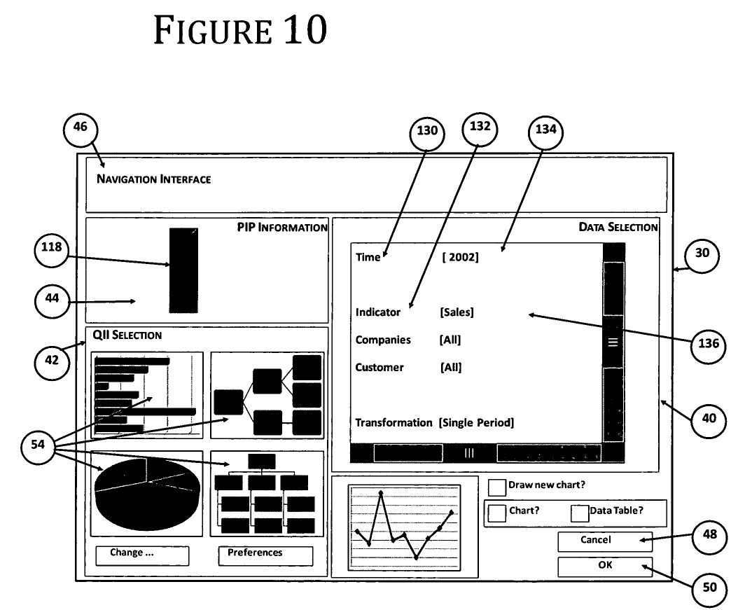

The user-selected PIP/s are then displayed within the PIP information area 44 of the navigation interface 30 illustrated in FIG. 10. In the illustrated example a single bar 118 of the trend bar chart of FIG. 8 has been selected, and is displayed in the PIP information area 44. The data point or points corresponding to the selected PIP or PIPs, together with the vector/s of the dimension elements that define that or those specific data point or points, are cached within the PIP data component 16 of memory 6. The vector or vectors of dimension elements corresponding to the selected PIP or PIPs is or are displayed in the Data Selection area 40 of the navigation interface 30.

For the described embodiment, the primary dimension of time 130 is displayed in data selection area 40, with the other dimensions being reserve dimensions, for example company dimension 137. Time has only one element 134 (year 2002) displayed, and the Indicator dimension 132 has sales of units element 136 displayed. Time is a primary dimension firstly because it was designated as such by the user when specifying the data to be retrieved and the QII format. However, in a chronological trend chart time is the dimension over which values are compared and therefore is a pivotal dimension for obtaining the information of interest, i.e. a trend over time, therefore it is a primary dimension.

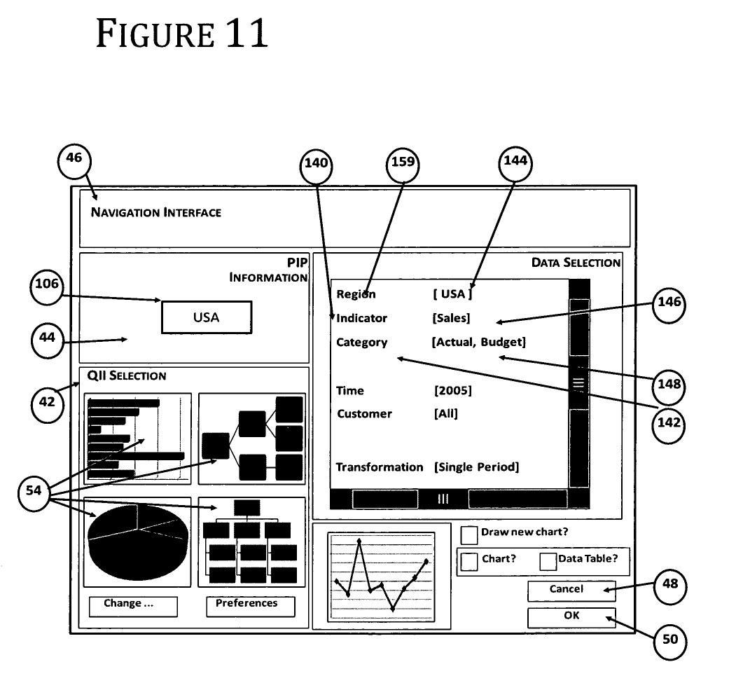

Another example is illustrated in FIG. 11, where the “USA” bar 106 of the “bridge diagram” of FIG. 10 has been selected as a PIP. There are three primary dimensions; region 138, indicator 140 and “calc” 142 (a calculation dimension whose elements are various calculations used for analysing data). Region has only one element, USA, 144, as does indicator whose element is sales value 146 and “calc” whose element is actual minus budget 148. The primary dimensions were chosen by the user as such in the request phase as they all comprise values which are part of the comparison the user wished to make.

The user can then choose another QII, for example because they think it will help them progress the displayed analysis further and reveal more information. The user can do this by nominating the next preferred QII, either a chart or a data table, within the QII navigation interface 30. If a chart is selected, the user then selects the preferred chart within the QII selection area 42 of the navigation interface 30. For example, the user may “mouse” over a displayed QII format option 54 by moving the pointer of a pointing device over each QII format option 54 and “clicking” on a desired format.

If the user wishes to view a table then they select a chart and then actuate “chart/table” toggle button 47 to request a table corresponding to the chart they had selected. This may also be performed when first beginning the analysis. One or more data point value in a table may be a Pathfinder Information Point, and selecting such a data point value will result in the corresponding dimensions and elements defining the data point value being displayed in the interface screen in the same manner as for selecting a PIP of a chart.

The user may then use the pointing device to reconfigure, if necessary, which of the dimensions listed in the data selection section 40 of the navigation interface 30 should be primary dimensions. The user may then also change the element settings for each dimension—whether primary or reserve dimensions—that are relevant to the QII that has been selected. When he clicks on the user-actuable screen-based button 50 marked ‘OK’, executable code causes a Request Document, initiated by State Data, to be forwarded to the Operational Data component as described above.

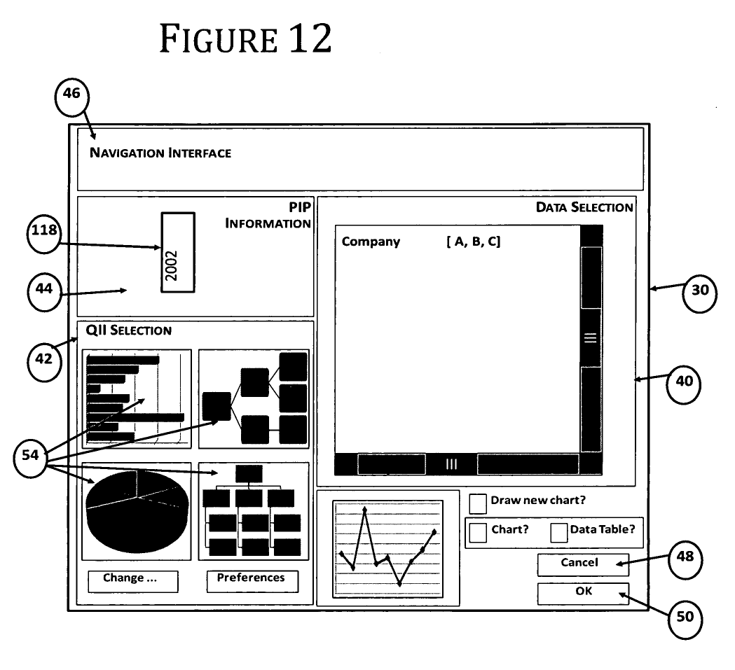

An example of a navigation interface 30 where a user has modified the request data is illustrated in FIG. 12. The user has selected bar 118 of the bar chart of FIG. 8 as a PIP, and this is displayed in the PIP information area 44. However, the user has selected the company dimension 137 (a dimension which has respective companies as elements) as the primary dimension. This is now at the top of the list in the data selection area 40 and marked with a “P”. Of the companies available the user has selected elements A, B and C. If there were only three companies, A, B and C, the user may have put the element “All” provided such an element existed. The reserve dimensions are Time (2002), Indicator (no. of unit sales), and Customer (All). Additionally, the user selects a bar chart as the QII format.

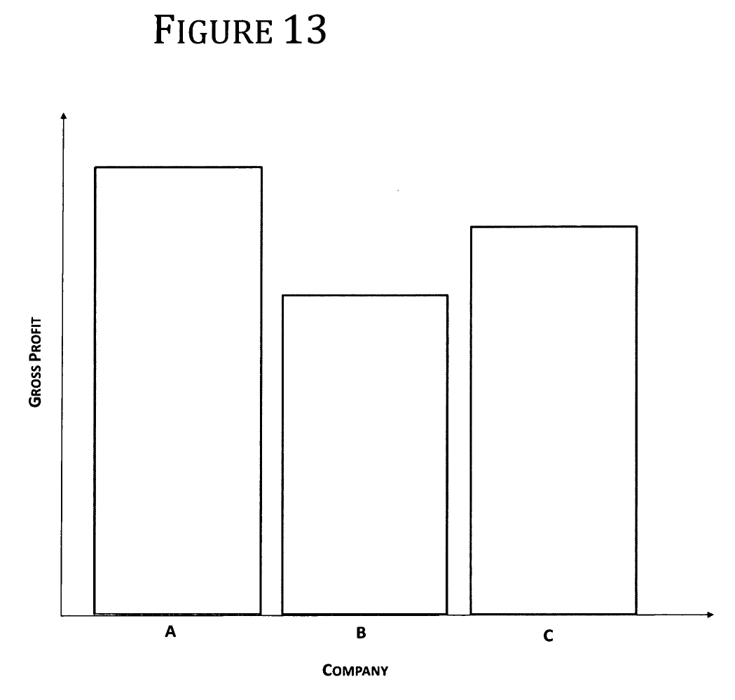

Actuation of the “OK” button 50 results in the process of requesting data and responding described above being conducted and resulting in the display of a new QII 35 as illustrated in FIG. 13. As can be seen, the new QII 35 provides insight into the unit sales performance of companies A, B and C compared to each other for the year 2002.

The state data 27 is utilised by the navigation component 30 in the display of a QII in a number of ways.

As described above, the state data 37 stores information regarding what QII 35 is currently being displayed, what QII formats 54 are available to a user to choose from, what the dimensions 53 and elements 55 for the current QII 35 are, for example. This information is what is displayed in the navigation interface 30 as described above.

The state data 37 is updated when the user makes any selection or changes a selection in the navigation interface 30. Prior to a change in a selection being made, equilibrium exists within the state data because of the equivalence of the requirements that are stored in the state data 37. For example, selections and settings specified in the navigation interface form a one part of the state data 37 and the cached availability of both the required data and the displayed QII 35 form a second part of the state data 37. The first and second part should be equivalent in terms of the data they store for a user request having been made and fulfilled. However, as soon as the user changes the settings within the navigation interface 30, for example when requesting new data and QII described with reference to FIGS. 12 and 13, a state of disequilibrium exists in the state data 37 because either/both available cached data and/or the QII are missing. This disequilibrium prompts the navigation component 30 to both initiate a request document 33 which is passed to the operational data component 12, and obtain QII template data 36 for creating the new, user-specified QII.

The cycle of navigation interface 30 display, user-selection of a PIP, user-specification of a follow-on QII, data request, data response and subsequent QII display can be repeated without limit by a user.

In view of the foregoing description it will be evident to a person skilled in the art that various modifications may be made within the scope of the invention. For example, embodiments of the invention may include stand alone data processing apparatus, or the processing may be distributed over a network with different data processing apparatus implementing different parts of the navigation module, and coupled over a computer network or telecommunications network.

Additionally, selection of a displayed PIP (data point value), dimension or element by a user may be achieved in any suitable way consistent with the data processing apparatus that is being used. Likewise, manipulation and configuration of the extension interface may also be conducted in any suitable manner. It should also be recognized that the interface screens illustrated in the drawings are by way of example only, and other configuration of user interface screens may be implemented.

Furthermore, the types of charts or tables which may be utilised in embodiments of the present invention are not limited to those explicitly referred to or described in the present disclosure, but includes any chart or table suitable for representing the data values stored in the database or databases to which an embodiment of the invention is being applied.

Insofar as embodiments of the invention described above are implementable, at least in part, using a software-controlled programmable processing device such as a general purpose processor or special-purposes processor, digital signal processor, microprocessor, or other processing device, data processing apparatus or computer system it will be appreciated that a computer program for configuring a programmable device, apparatus or system to implement the foregoing described methods, apparatus and system is envisaged as an aspect of the present invention.

The computer program may be embodied as any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. A skilled person would readily understand that term “computer” in its most general sense encompasses programmable devices such as referred to above, and data processing apparatus and computer systems.

Suitably, the computer program is stored on a carrier medium in machine readable form, for example the carrier medium may comprise memory, removable or non-removable media, erasable or non-erasable media, writeable or re-writeable media, digital or analog media, hard disk, floppy disk, Compact Disk Read Only Memory (CD-ROM), Company Disk Recordable (CD-R), Compact Disk Rewriteable (CD-RW), optical disk, magnetic media, magneto-optical media, removable memory cards or disks, various types of Digital Versatile Disk (DVD), tape, cassette solid-state memory. The computer program may be supplied from a remote source embodied in the communications medium such as an electronic signal, radio frequency carrier wave or optical carrier waves. Such carrier media are also envisaged as aspects of the present invention.

It will be appreciated that any of the application programs, or any other logical module, may be made up of more than one functional unit that may be distributed across more than one server/computer. The one or more server computers may or may not be in the same physical location.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

The scope of the present disclosure includes any novel feature or combination of features disclosed therein either explicitly or implicitly or any generalisation thereof irrespective of whether or not it relates to the claimed invention or mitigate against any or all of the problems addressed by the present invention. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

What is claimed is:

1. A navigation module for a structured database having a multiplicity of dimensions, said navigation module operative to:
a. cause a user interface to present one or more data point values retrieved from said database and to receive user input;
b. respond to user selection of one or more presented data point values by causing said user interface to present a first element indicium representative of an element of one or more data point vectors defining a location of said one or more user selected data point values within said database;
c. respond to user input to present a second element indicium associated with said first element;
d. retrieve from said structured database one or more new data point values corresponding to one or more new data point vectors defined by user selection of said second element indicium; and
e. cause said user interface to present said one or more new data point values.

2. A navigation module according to claim 1, responsive to user selection of said first element indicium to present a said second element indicium which is associated with said first element.

3. A navigation module according to claim 2, further operative such that said second element is an element along the same dimension of said structured database as said first element.

4. The navigation module of claim 1, further operative to respond to user input defining a data presentation type to present via said user interface said one or more new data point values in accordance with said data presentation type.

5. The navigation module of claim 1, further operative to receive user input via said user interface.

6. The navigation module of claim 1, wherein said user interface resource comprises a visual display unit.

7. A data processing apparatus including the navigation module of claim 1, comprising a processing resource and a memory resource.

8. A computer system including the data processing apparatus of claim 7, comprising an interface and a visual display unit.

9. The computer system of claim 8, further comprising a structured database.

10. A computer network comprising a first node at which the computer system of claim 8 is located; and a second node at which a structured database is located.

11. The computer network of claim 10 implemented over a telecommunications network.

12. A computer program, comprising computer program elements operative when executed on a data processing apparatus to implement the navigation module of claim 1.

13. A computer program carrier medium, carrying the computer program of claim 12.

14. The computer program carrier medium of claim 13, comprising one or more of the following: memory, removable or non-removable media, erasable or non-erasable media, writeable or re-writeable media, digital or analog media, hard disk, floppy disk, Compact Disk Read Only Memory (CD-ROM), Company Disk Recordable (CD-R), Compact Disk Rewriteable (CD-RW), optical disk, magnetic media, magneto-optical media, removable memory cards or disks, Digital Versatile Disk (DVD), tape, cassette solid-state memory, an electronic signal, radio frequency carrier wave or optical carrier waves.

15. A navigation module for a structured database having a multiplicity of dimensions, said navigation module operative to:
a. cause a user interface to present one or more data point values retrieved from said database and to receive user input;
b. respond to user selection of one or more presented data point values by causing said user interface to present a first dimension indicium representative of a first dimension of one or more data point vectors defining a location of said one or more user selected data point values within said database, and wherein said first dimension indicium is arranged to be indicative of said first dimension being a primary dimension influencing the form in which said one or more user selected data point values are presented; and
c. to respond to user input designating a second dimension of said one or more data point vectors as a primary dimension and influential on the form in which data point values are presented by causing one or more data point values retrieved from said structured database to be presented in accordance with said second dimension being designated a primary dimension.

16. The navigation module of claim 15, further operative to:
a. respond to user selection of one or more presented data point values by causing said user interface to present a first element indicium representative of an element of one or more data point vectors defining a location of said one or more user selected data point values within said database;
b. respond to user input by presenting a second element indicium associated with said first element;
c. retrieve from said structured database one or more new data point values corresponding to one or more new data point vectors defined by user selection of said second element indicium; and
d. cause said user interface to present said one or more new data point values.

17. The navigation module of claim 15, further operative to limit the number of elements that may be selected for dimensions not designated primary dimensions to one.

18. The navigation module of claim 15, further operative to present a second dimension indicium representative of said second dimension responsive to said user selection of one or more presented data point values.

19. The navigation module of claim 18, wherein the navigation module is responsive to a user arranging said second dimension indicium to be indicative of being designated a primary dimension by designating said second dimension as a primary dimension.

20. The navigation module of claim 15, wherein the navigation module is responsive to user input to designate both first and second dimensions as primary dimensions.

21. The navigation module of claim 15, further operative to respond to a dimension being designated as a primary dimension to present data values in a form in which data values along said primary dimension may be compared.

22. The navigation module of claim 15, further operative to respond to a dimension being designated as a primary dimension to present data values in a form in which said dimension forms an axis of a graphical presentation.

23. The navigation module of claim 15, further operative to respond to a dimension being designated as a primary dimension to present data values in a form in which more than one data value along said primary dimension is presented.

24. The navigation module of claim 15, further operative to respond to user input defining a data presentation type to present via said user interface said one or more new data point values in accordance with said data presentation type.

25. The navigation module of claim 24, wherein said data presentation type is a graphical representation.

26. A method of operating a data processing apparatus for navigating a structured database having a multiplicity of dimensions, said method comprising:
a. causing a user interface to present one or more data point values retrieved from said database and receiving user input;
b. responding to user selection of one or more presented data point values by causing said user interface to present a first element indicium representative of an element of one or more data point vectors defining a location of said one or more user selected data point values within said database;
c. responding to user input to present a second element indicium associated with said first element;
d. retrieving from said structured database one or more new data point values corresponding to one or more new data point vectors defined by user selection of said second element indicium; and
e. causing said user interface to present said one or more new data point values.

27. The method of claim 26, further comprising responding to user selection of said first element indicium to present a said second element indicium which is associated with said first element.

28. The method of claim 27, wherein said second element is an element along the same dimension of said structured database as said first element.

29. A method of operating a data processing apparatus for navigating a structured database having a multiplicity of dimensions, said method comprising:
a. causing a user interface to present one or more data point values retrieved from said database and receiving user input;
b. responding to user selection of one or more presented data point values by causing said user interface to present a first dimension indicium representative of a first dimension of one or more data point vectors defining a location of said one or more user selected data point values within said database, and arranging said first dimension indicium to be indicative of said first dimension being a primary dimension influencing the form in which said one or more user selected data point values are presented; and
c. responding to user input designating a second dimension of said one or more data point vectors as a primary dimension and influential on the form in which data point values are presented by causing one or more data point values retrieved from said structured database to be presented in accordance with said second dimension being designated a primary dimension.

30. The method of claim 29, further comprising:
a. responding to user selection of one or more presented data point values by causing said user interface to present a first element indicium representative of an element of one or more data point vectors defining a location of said one or more user selected data point values within said database;
b. responding to user input by presenting a second element indicium associated with said first element;
c. retrieving from said structured database one or more new data point values corresponding to one or more new data point vectors defined by user selection of said second element indicium; and
d. causing said user interface to present said one or more new data point values.

31. The method of claim 29, further comprising limiting the number of elements that may be selected for dimensions not designated primary dimensions to one.

32. The method of claim 29, further comprising presenting a second dimension indicium representative of said second dimension responsive to said user selection of one or more presented data point values.

33. The method of claim 32, further comprising responding to a user arranging said second dimension indicium to be indicative of being designated a primary dimension by designating said second dimension as a primary dimension.

34. The method of claim 29, further comprising responding to user input by designating both first and second dimensions as primary dimensions.

35. The method of claim 29, further comprising responding to a dimension being designated as a primary dimension by presenting data values in a form in which data values along said primary dimension may be compared.

36. The method of claim 29, further comprising responding to a dimension being designated as a primary dimension by presenting data values in a form in which said dimension forms an axis of a graphical presentation.

37. The method of claim 28, further comprising responding to a dimension being designated as a primary dimension by presenting data values in a form in which more than one data value along said primary dimension is presented.

38. The method of claim 29, further comprising responding to user input defining a data presentation type by presenting via said user interface said one or more new data point values in accordance with said data presentation type.

39. The method according to claim 38, wherein said data presentation type is a graphical representation.

40. The method of claim 29, further comprising receiving user input via said user interface.

41. The method of claim 29, wherein said user interface resource comprises a visual display unit.

42. A computer program, comprising computer program elements operative when executed on a data processing apparatus to implement the method of claim 26.

43. A computer program carrier medium, carrying the computer program of claim 42.

44. The computer program carrier medium of claim 43, comprising one or more of the following: memory, removable or non-removable media, erasable or non-erasable media, writeable or re-writeable media, digital or analog media, hard disk, floppy disk, Compact Disk Read Only Memory (CD-ROM), Company Disk Recordable (CD-R), Compact Disk Rewriteable (CD-RW), optical disk, magnetic media, magneto-optical media, removable memory cards or disks, Digital Versatile Disk (DVD), tape, cassette solid-state memory, an electronic signal, radio frequency carrier wave or optical carrier waves.
